(19) United States
(12) Patent Application Publication
(10) Pub. No.: US 2007/0025609 A1
(43) Pub. Date: Feb. 1, 2007

(54) METHOD OF DETECTING DEFECT OF A PATTERN IN A SEMICONDUCTOR DEVICE

(76) Inventors: Sung-Gon RYU, Gyeonggi-do (KR); Kyu-Hong LIM, Gyeonggi-do (KR); Hyung-Suk CHO, Gyeonggi-do (KR); Sung-Kweon KIM, Gyeonggi-do (KR)

Correspondence Address: MARGER JOHNSON & MCCOLLOM, P.C., 210 SW MORRISON STREET, SUITE 400, PORTLAND, OR, 97204, US

(21) Appl. No.: 11/460,574

(22) Filed: Jul. 27, 2006

(30) Foreign Application Priority Data
Jul. 28, 2005 (KR) 2005-68677

(51) Int. Cl. G06K 9/00

(52) U.S. Cl. 382/149

(57) ABSTRACT

In a method of detecting a defect of the pattern in a semiconductor device, the pattern to be inspected is formed on a substrate, and then a thin film is continuously formed on the pattern, the defect of the pattern and the substrate to accurately detect the defect. The thin film has a reflectivity substantially greater than that of the pattern. The defect of the pattern is detected by inspecting the substrate having the thin film covering the pattern and the defect. A minute defect of the pattern such as residues or a micro bridge may be readily detected.

### CROSS-REFERENCE TO RELATED APPLICATION

This application claims priority under 35 U.S.C. §119 to Korean Patent Application No. 2005-68677 filed on Jul. 28, 2005, the contents of which are incorporated herein by reference in their entirety.

### BACKGROUND OF THE INVENTION

1. Field of the Invention

The present invention relates to a method of detecting a defect of a pattern in a semiconductor device. More particularly, example embodiments of the present invention relate to a method of detecting a defect of a pattern in a semiconductor device such as residues or a micro bridge.

2. Description of the Related Art

Semiconductor devices are generally manufactured through a fabrication (FAB) process of forming integrated circuits on a substrate, an electrical die sorting (EDS) process for inspecting electrical characteristics of the integrated circuits, and a packaging process for separating individual semiconductor devices.

The FAB process further includes a deposition process for forming a layer on the substrate, a polishing process for planarizing the layer positioned on the substrate, a photo process for forming a photoresist pattern on the layer, an etching process for etching the layer to form electrical patterns on the substrate, an ion implantation process for forming a impurity region in the substrate, a cleaning process for removing particles from the substrate, and an inspecting process for detecting defects of the substrate, the layer, the patterns, etc.

As the semiconductor devices have relatively reduced design rules and become highly integrated, minute defects that would not have generally caused any effects on electrical characteristics of the semiconductor devices may now seriously affect on the electrical characteristics of current semiconductor devices. Thus, yields of the semiconductor devices may be deteriorated and reliabilities of the semiconductor devices may be reduced because of the minute defects generated in the semiconductor devices. Therefore, the inspecting process becomes more important to improve the electrical characteristics and the reliability of a semiconductor device.

In the inspecting process for detecting defects of a semiconductor device, patterns repeatedly formed on a substrate are compared to one another so that an abnormal pattern may be detected. The abnormal pattern may be more exactly detected when an S/N ratio (i.e., a ratio between signal and noise) obtained from the patterns is very large. Namely, the inspecting process may be more precisely carried out when the signal generated from the abnormal pattern is very large whereas the noise generated from a normal pattern is very small because the very large signal of the abnormal pattern may be apparently distinguished from the very small noise of the normal pattern.

The S/N ratio may greatly vary in accordance with various factors such as properties of a layer, the size of a defect, the position of the pattern, characteristics of the light used in an inspection apparatus, etc. When one of the various factors is insufficient for precisely detecting the patterns, the S/N ratio may be considerably reduced so that the abnormal pattern may not be exactly detected. However, the current semiconductor device has very minute patterns to improve the integration degree thereof so that the defect of the very minute pattern may not be exactly detected because the abnormal pattern may not be apparently distinguished from a normal pattern.

In particular, defects such as residues on the patterns or micro bridges between the patterns may not be frequently detected in the inspecting process. These defects may be numerously generated in the patterns when one of the photo process, the etching process and the cleaning process may be abnormally performed in a manufacturing process for forming the patterns. When these defects may not be detected and cured in time, successive manufacturing processes may generate the same defects, thereby deteriorating the yield and electrical characteristics of the semiconductor devices.

### SUMMARY OF THE INVENTION

Embodiments of the present invention provide a method of accurately detecting a minute defect of a pattern in a semiconductor device. The method of detecting a defect of a pattern in a semiconductor device may comprise forming the pattern to be inspected on a substrate. Then, a thin film is continuously formed on the pattern, the defect of the pattern and the substrate to accurately detect the defect. The thin film has a reflectivity substantially greater than that of the pattern.

The defect of the pattern is detected by inspecting the substrate having the thin film covering the pattern and the defect. The defect of the pattern in one embodiment comprises residues on the pattern or a micro bridge between adjacent patterns.

The pattern preferably comprises polysilicon or single crystalline silicon. The thin film preferably comprises metal, and more preferably comprises titanium nitride or titanium.

In one embodiment, detecting the defect of the pattern is performed using an optical inspection apparatus. In another embodiment, detecting the defect of the pattern is carried out using a light having a wavelength of about 350 nm to about 450 nm. In a further embodiment, detecting the defect of the pattern comprises obtaining an image information by irradiating the light onto the substrate having the patterns and the thin film, and then detecting the defect of the pattern by comparing the image information with a reference information.

The image information preferably includes a gray level obtained from the defect of the pattern. In an embodiment, the method further comprises displaying the defect of the pattern using the image information.

According to the present invention, a thin film having a high reflectivity is formed on patterns to be inspected such that a defect of the patterns may be decorated by the thin film. Therefore, the defect such as residues on the patterns or a micro bridge between the patterns may be accurately detected using an optical inspection apparatus. When the defects are detected at an early stage in semiconductor manufacturing processes, the manufacturing productivity of the semiconductor device may be improved. In addition, the semiconductor device may have enhanced electrical characteristics and reliability by removing the detected defects in time.

### BRIEF DESCRIPTION OF THE DRAWINGS

The above and other features and advantages of the present invention will become readily apparent by reference to the following detailed description when considered in conjunction with the accompanying drawings wherein:

FIG. 1 is a flow chart illustrating a method of detecting a defect of a pattern in a semiconductor device in accordance with example embodiments of the present invention;

FIGS. 2 to 4 are cross-sectional views illustrating a method of detecting a defect of a pattern in a semiconductor device in accordance with example embodiments of the present invention;

FIGS. 5 and 6 are plan views illustrating a method of detecting a defect of a pattern in a semiconductor device in accordance with example embodiments of the present invention;

FIG. 7 is a graph illustrating reflection degrees of lights reflected from different thin films used for a semiconductor device in accordance with example embodiments of the present invention;

FIG. 8 is a graph illustrating signal/noise (S/N) ratios relative to wavelengths of light used for detecting a detect of polysilicon patterns after formation of a titanium nitride thin film on the polysilicon patterns;

FIG. 9 is an electron microscopic photograph illustrating a defect of a pattern in accordance with an embodiment of the present invention.

### DESCRIPTION OF THE EMBODIMENTS

The present invention is described more fully hereinafter with reference to the accompanying drawings, in which example embodiments of the present invention are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments of the present invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected.

Thus, embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Method of Detecting Defect of a Pattern

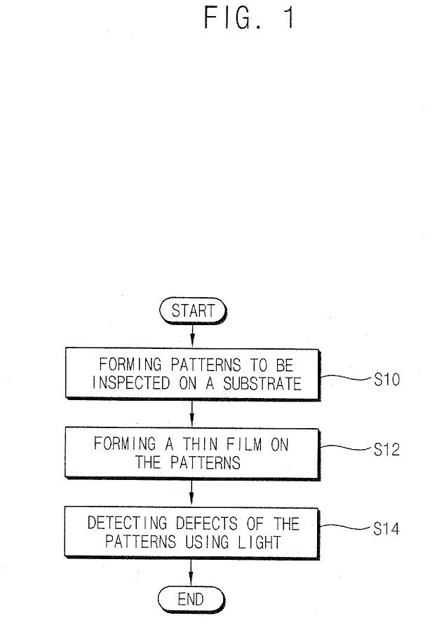

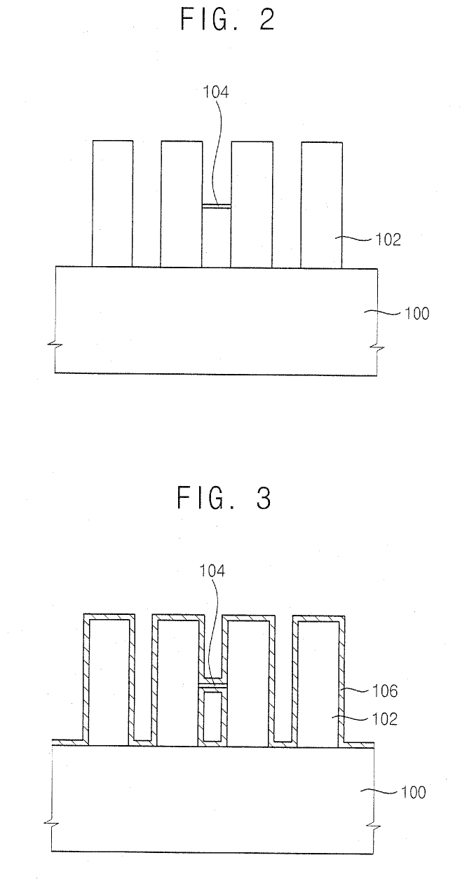

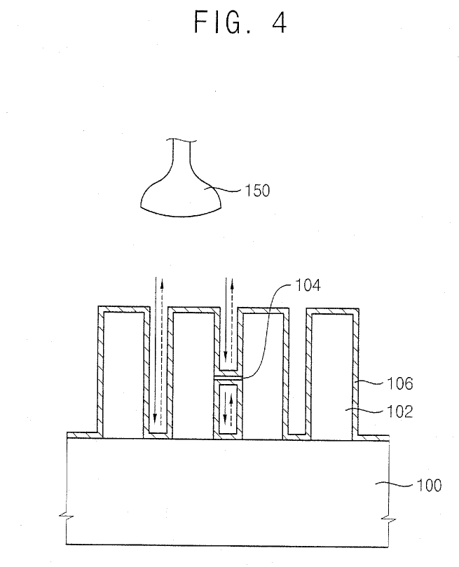

Referring to FIGS. 1, 2 and 5, patterns 102 to be inspected are formed on a substrate 100 in step S10. The substrate 100 may include a semiconductor substrate such as a silicon wafer or a silicon-on-insulator (SOI) substrate.

The patterns 102 to be inspected may have shapes in that lines and spaces are repeatedly aligned. Alternatively, the patterns 102 to be inspected may have island shapes spaced apart from one another by a predetermined space.

In an embodiment of the present invention, the patterns 102 to be inspected may be directly formed on the substrate 100. In another embodiment of the present invention, the patterns 102 to be inspected may be formed over the substrate 100 by interposing an insulating interlayer between the substrate 100 and the patterns 102 to be inspected.

The patterns 102 to be inspected may include polysilicon or single crystalline silicon. For example, the patterns 102 to be inspected may correspond to bit lines, word lines, interconnection pads, etc. Alternatively, the patterns 102 to be inspected may correspond to channel layers including single crystalline silicon.

In general, polysilicon patterns in a semiconductor device may have aspect ratios substantially higher than those of metal patterns. Additionally, a space between the polysilicon patterns may be substantially narrower than that between the metal patterns. Thus, residues may remain on the polysilicon patterns or a micro bridge may frequently occur between the polysilicon patterns during manufacturing processes for forming the polysilicon patterns on a substrate.

Meanwhile, an optical inspection apparatus may not apparently display images of the residues remaining on the polysilicon patterns or an image of the micro bridge between the polysilicon patterns because the polysilicon patterns have a reflectivity substantially lower than those of the metal patterns. Therefore, defects of the polysilicon patterns such as the residues or the micro bridge may not be exactly detected in an inspecting process for the polysilicon patterns.

Hereinafter, the manufacturing processes for forming the polysilicon patterns and the defects generated in the polysilicon patterns will be illustratively described.

After a polysilicon layer is formed on a substrate by a deposition process, a photoresist pattern (not shown) is formed on the polysilicon layer. The polysilicon layer is partially etched using the photoresist pattern as an etching mask to form the polysilicon patterns on the substrate. Here, a failure such as an unetched stringer may be generated between the polysilicon patterns when the polysilicon layer is not sufficiently etched in the etching process for forming the polysilicon patterns.

After the formations of the polysilicon patterns, the photoresist pattern is removed from the polysilicon patterns, and also the substrate having the polysilicon patterns is cleaned. In the process for removing the photoresist pattern and the process for cleaning the polysilicon patterns, residues may remain on the polysilicon patterns or a micro bridge may occur between the polysilicon patterns.

Since the residues and the micro bridge may have relatively thin thicknesses and also exist between sidewalls of the polysilicon patterns, the residues and the micro bridge may not be accurately detected. Particularly, when an optical inspection apparatus is employed for detecting defects of the polysilicon patterns such as the residues and the micro bridge, lights emitted from the optical inspection apparatus may pass through the residues and the micro bridge such that the defects of the polysilicon patterns may not be detected using the lights. That is, the optical inspection apparatus may not properly distinguish normal polysilicon patterns from the defects such as the residues or the micro bridge.

According to some embodiments of the present invention, a method for detecting a defect such as a micro bridge between the patterns to be inspected will be illustratively described.

Referring to FIGS. 1, 3 and 6, a thin film 106 is continuously formed on the patterns 102 to be inspected, on the defect 104 disposed between the patterns 102 to be inspected, and on the substrate 100 in step S12. The thin film 106 may be formed using a material that has a reflectivity substantially greater than those of the patterns 102 to be inspected. The thin film 106 may be formed by a chemical vapor deposition (CVD) process or a physical vapor deposition (PVD) process. The thin film 106 having the high reflectivity may be referred to as a surface film.

The thin film 106 may increase the light reflectivity of the defect 104 and the light reflectivity of the patterns 102 to be inspected. Thus, an optical inspection apparatus may accurately detect the defect 104 generated between the patterns 102 to be inspected. When the patterns 102 to be inspected include polysilicon, the thin film 106 may be formed using metal or a metal compound having a reflectivity substantially greater than the reflectivity of polysilicon.

When the thin film 106 may not have a uniform thickness on the patterns 102 to be inspected, a surface profile of the thin film 106 covering the patterns 102 may be considerably different from surface profiles of the patterns 102 so that the optical inspection apparatus may not precisely detect the defect 104 between the patterns 102 to be inspected. Therefore, the thin film 106 having the high reflectivity may be formed using a material that has good step coverage to ensure the uniform thickness thereof

When the thin film 106 has a poor surface morphology, more noises may be detected by the optical inspection apparatus such that the optical inspection apparatus may not also exactly detect the defect 104 between the patterns 102 to be inspected. Thus, the thin film 106 may be formed using a material that has a good surface morphology.

When the thin film 106 has a relatively thick thickness on the patterns 102, the surface profile of the thin film 106 covering the patterns 102 may be greatly different from those of the patterns 102 to be inspected. Therefore, the thin film 106 may have a thickness corresponding to a half of a gap between the patterns 102 to be inspected.

In example embodiments of the present invention, the thin film 106 may be formed using titanium nitride (TiN) or titanium (Ti) because titanium nitride and titanium may ensure a good step coverage, a good surface morphology and a thin thickness. When the thin film 106 includes titanium, the thin film 106 may be changed into titanium silicide (TiSi_{X}) in accordance with a reaction between titanium and polysilicon contained in the patterns 102 to be inspected so that the thin film 106 may not have a uniform thickness on the patterns 102 to be inspected. Therefore, the thin film 106 may be advantageously formed using titanium nitride.

When the thin film 106 is formed using tungsten (W), the thin film 106 may have a poor surface morphology. Further, the thin film 106 may have a poor step coverage when the thin film 106 is formed using aluminum (Al).

The light reflectivity of the patterns 102 and the defect 104 may increase in accordance with the formation of the thin film 106. Additionally, since the defect 104 may have an increased thickness together with a portion of the thin film 106 covering the defect 104, the light emitted from the optical inspection apparatus may be sufficiently reflected from the defect 104, effectively scattered on the defect 104, and absorbed to the defect 104. Hence, the defect 104 of the patterns 102 may be enhanced to be more easily detected by the optical inspection apparatus.

Referring to FIGS. 1 and 4, in step S14, the defect 104 is detected by inspecting the substrate 100 having the patterns 102 and the thin film 106 using the light.

In some embodiments of the present invention, the light emitted from the optical inspection apparatus is irradiated onto the substrate 100 having the thin film 106 and the patterns 102 to be inspected. A detector 150 of the optical inspection apparatus detects the light reflected and/or scattered from the substrate 100 having the thin film 106 and the patterns 102 to be inspected.

When a proper light is used in detecting the detect 104 of the patterns 102, the optical inspection apparatus may not exactly distinguish the defect 104 from the normal patterns 102 because a ratio of signal to noise (S/N ratio) is low. Thus, a light having a maximum S/N ratio relative to the defect 104 and the patterns 102 may be advantageously used so as to precisely detect the defect 104 of the patterns 102. In an embodiment of the present invention, a light having a wave length of about 350 nm to about 450 nm may be used to detect the defect 104 when the patterns 102 to be inspected include polysilicon and the thin film 106 includes titanium nitride.

After the detector 150 receives the light reflected and/or scattered from the substrate 100 having the thin film 106, the defect 104 and the patterns 102, image information of the patterns 102 having the thin film 106 is obtained from the detected light by the detector 150 of the optical inspection apparatus. In an embodiment of the present invention, the intensity of the detected light may be converted into an electrical signal, and then the electrical signal may be changed into an image signal. Hence, the image information of the patterns 102 having thin film 106 may be obtained by the optical inspection apparatus. The image information may include gray levels of pixels obtained relative to each of regions of the substrate 100 having the patterns 102 and the thin film 106. Here, a gray level of a pixel corresponding to the defect 104 is different from gray levels of pixels corresponding to the normal patterns 102 to be inspected.

The defect 104 of the patterns 102 is finally detected by comparing the image information with reference information previously set.

In an embodiment of the present invention, the detected defect 104 of the patterns 102 may be displayed as an image using a display device of the optical inspection apparatus. When the defect 104 of the patterns 102 is displayed, the image of the defect 104 may be somewhat darker or lighter than those of the normal patterns 102 to be inspected.

According to some embodiments of the present invention, a thin film may be formed on patterns to be inspected and a defect of the patterns so as to detect the defect of the patterns before inspecting the defect of the patterns to be inspected. In addition, a light having a maximum S/N ratio relative to the defect and the patterns may be used to exactly detect the defect of the patterns. Hence, the defect of the patterns may be easily and precisely detected because a difference between a gray level of a pixel corresponding to the defect and gray levels of pixels corresponding to the patterns may be considerably increased.

Measurement of Light Reflectivity of Thin Films

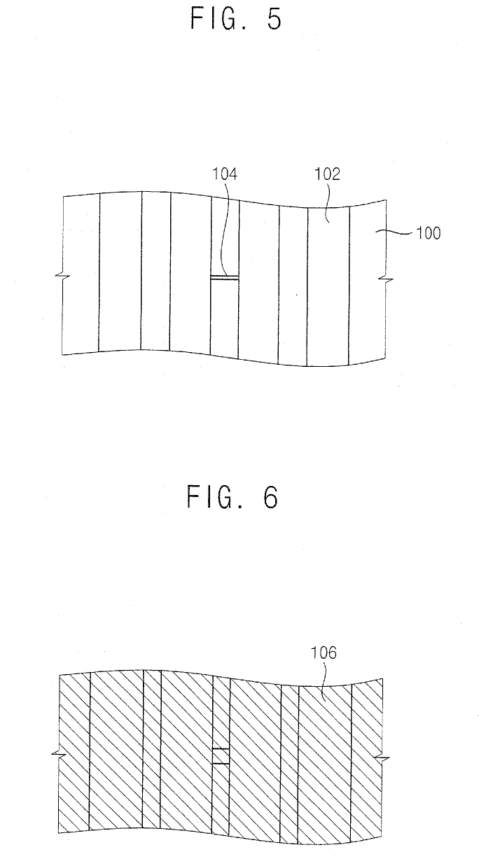

FIG. 7 is a graph illustrating reflection degrees of lights reflected from different thin films used for a semiconductor device in accordance with exemplary embodiments of the present invention. In FIG. 7, a reference numeral 202 indicates a light reflectivity of a titanium nitride thin film formed on a substrate after irradiating a light having a wavelength of about 248 nm onto the substrate. A reference numeral 200 represents a light reflectivity of the titanium nitride thin film on the substrate after irradiating a light having a wavelength of about 480 nm onto the substrate. Additionally, a reference numeral 206 indicates a light reflectivity of a polysilicon thin film formed on the substrate after irradiating a light having a wavelength of about 248 nm onto the substrate, and a reference numeral 204 means a light reflectivity of the polysilicon thin film formed on the substrate after irradiating a light having a wavelength of about 480 nm onto the substrate. In FIG. 7, an X-axis represents portions of the thin films where the light reflectivity is measured, and a Y-axis denotes relative light reflectivity of the thin films when a light reflectivity of a bare silicon wafer is 100.

As shown in FIG. 7, the light reflectivity of the titanium nitride thin films 200 and 202 is substantially twice greater than the light reflectivity of the polysilicon thin films 204 and 206. Therefore, a light reflectivity of a defect of the pattern may be considerably increased when the titanium nitride thin films is formed on the defect and the patterns. As a result, the defect of the patterns may be easily detected when the titanium nitride thin film having the high light reflectivity covers the defect and the patterns.

Evaluation of Detecting a Defect Relative to Wavelengths of Light

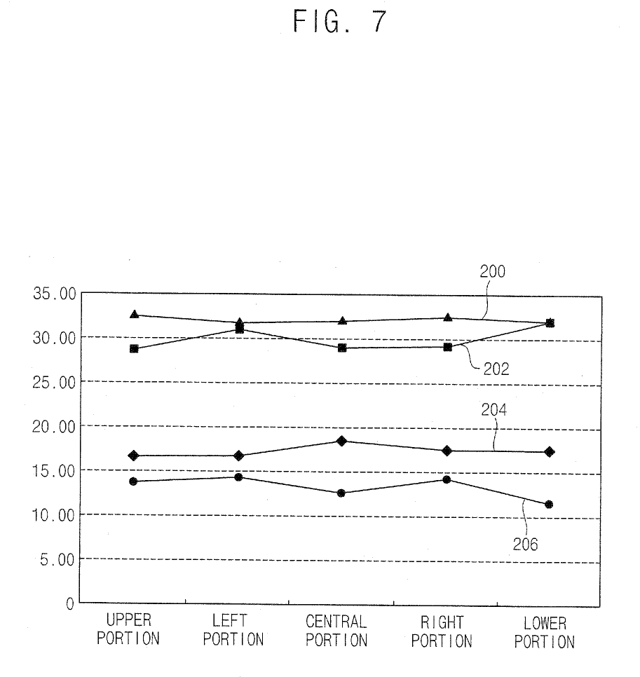

FIG. 8 is a graph illustrating S/N ratios relative to wavelengths of light used for detecting a defect of polysilicon patterns after a formation of a titanium nitride thin film on the polysilicon patterns. In FIG. 8, a reference numeral 300 represents gray levels of pixels measured using a light having a wavelength of about 266 nm, and a reference numeral 302 indicates gray levels of pixels measured using a light having a wavelength of about 350 nm to about 450 nm.

Referring to FIG. 8, when the light having the wavelength of about 266 nm is used for defecting the defect of the polysilicon patterns, an S/N ratio relative to the defect and the polysilicon patterns is not sufficiently high so that the defect may not distinguished from normal polysilicon patterns. When images of the defect and the normal polysilicon patterns are obtained, an image of the defect may not distinguished from images of the normal polysilicon patterns.

When the light having the wavelength of about 350 nm to about 450 nm is used for detecting the defect of the polysilicon patterns, a gray level 304 of the defect is somewhat lower than the gray levels of the normal polysilicon patterns. When images of the defect and the normal polysilicon patterns are displayed, an image of the defect may be somewhat darker than images of the normal polysilicon patterns.

Although a light having the wavelength of about 460 nm to about 600 nm is used for detecting the defect of the polysilicon patterns, the S/N ratio relative to the defect and the polysilicon patterns is not sufficiently high so that the defect may not be distinguished from the normal polysilicon patterns.

As described above, minute defect of the polysilicon patterns may be exactly detected using the light having the wavelength of about 350 nm to about 450 nm when the titanium nitride thin film is formed on the polysilicon patterns.

Evaluation of a Detected Defect

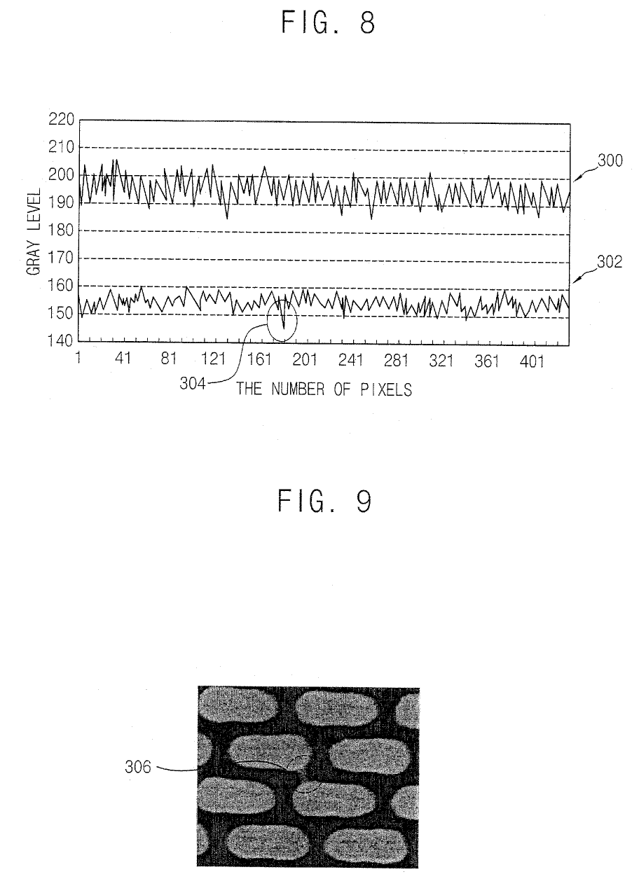

FIG. 9 is an electron microscopic picture illustrating a defect of a pattern in accordance with an example embodiment of the present invention. In FIG. 9, the electron microscopic picture is obtained using a scanning electron microscope (SEM). An image of the defect of the pattern is obtained to identify a type of the defect detected using an optical inspection apparatus.

As shown in FIG. 9, the defect of the pattern may correspond to a micro bridge 306 when the image of the detected defect of the pattern is obtained using the optical inspection apparatus and the SEM.

In a conventional inspection method for detecting a defect of a pattern, the defect such as residues and a micro bridge between the patterns may not be detected by an optical inspection apparatus. However, according to example embodiments of the present invention, the defect such as the micro bridge 306 may be easily defected using the optical inspection apparatus because a thin film having a high light reflectivity is formed on the defect and the patterns and the defect is decorated by the thin film.

According to the present invention, a thin film having a high light reflectivity is formed on patterns to be inspected such that a defect of the patterns to be inspected may be enhanced by the thin film. Therefore, the defect such as residues on the patterns or a micro bridge between the patterns may be accurately detected using an optical inspection apparatus. When the defect is detected at an early stage of a semiconductor device manufacturing processes, a yield and a manufacturing productivity of the semiconductor device may be improved. In addition, the semiconductor device may have enhanced electrical characteristics and reliability by removing the defect detected at an early stage.

The foregoing is illustrative of the present invention and is not to be construed as limiting thereof. Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

What is claimed is:

1. A method of detecting a defect of a pattern in a semiconductor device, comprising:
forming the pattern to be inspected on a substrate;
continuously forming a thin film on the pattern, the defect of the pattern and the substrate, respectively, to accurately detect the defect, wherein the thin film has a reflectivity substantially greater than the reflectivity of the pattern; and
detecting the defect of the pattern by inspecting the substrate having the thin film covering the pattern and the defect.

2. The method of claim 1, wherein the pattern comprises polysilicon or single crystalline silicon.

3. The method of claim 1, wherein the thin film comprises a metal.

4. The method of claim 3, wherein the thin film comprises titanium nitride or titanium.

5. The method of claim 1, wherein the defect of the pattern comprises residues on the pattern or a micro bridge between adjacent patterns.

6. The method of claim 1, wherein detecting the defect of the pattern is performed using an optical inspection apparatus.

7. The method of claim 6, wherein detecting the defect of the pattern is carried out using a light having a wavelength of about 350 nm to about 450 nm,

8. The method of claim 6, wherein detecting the defect of the pattern comprises:
obtaining an image information by irradiating a light onto the substrate having the patterns and the thin film; and
detecting the defect of the pattern by comparing the image information with a reference information.

9. The method of claim 8, wherein the image information comprises a gray level obtained from the defect of the pattern.

10. The method of claim 8, further comprising displaying the defect of the pattern using the image information.

11. A method of detecting a defect of a pattern in a semiconductor device, comprising:
forming the pattern to be inspected on a substrate, the pattern comprising silicon;
continuously forming a thin metal film on the pattern, the defect of the pattern and the substrate, respectively, to accurately detect the defect, wherein the thin metal film has a reflectivity substantially greater than the reflectivity of the pattern; and
detecting the defect of the pattern by inspecting the substrate having the thin metal film covering the pattern and the defect.

12. The method of claim 11, wherein the pattern comprises polysilicon or single crystalline silicon.

13. The method of claim 11, wherein the thin metal film comprises titanium nitride.

14. The method of claim 11, wherein the thin metal film comprises titanium.

15. The method of claim 11, wherein the defect of the pattern comprises residues on the pattern or a micro bridge between adjacent patterns.

16. The method of claim 11, wherein detecting the defect of the pattern is performed using an optical inspection apparatus.

17. The method of claim 16, wherein detecting the defect of the pattern is carried out using a light having a wavelength of about 350 nm to about 450 nm.

18. The method of claim 16, wherein detecting the defect of the pattern comprises:
obtaining an image information by irradiating a light onto the substrate having the pattern and the thin metal film; and
detecting the defect of the pattern by comparing the image information with a reference information.

19. The method of claim 18, wherein the image information comprises a gray level obtained from the defect of the pattern.

20. The method of claim 18, further comprising displaying the defect of the pattern using the image information.
